(19) United States
(12) Patent Application Publication
(10) Pub. No.: US 2003/0136859 A1
(43) Pub. Date: Jul. 24, 2003

(54) Method of applying two-component pavement markings and apparatus

(75) Inventors: Thomas R. Borden, Oakdale, MN (US); David C. May, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/050,477

(22) Filed: Jan. 18, 2002

(51) Int. Cl. B05D 1/00

(52) U.S. Cl. 239/1

(57) ABSTRACT

The invention relates to a method of applying a two-component composition and in particular a two-component pavement marking composition as well as an apparatus suitable for mixing, dispensing and spraying small volumes of a two-component composition.

### FIELD OF THE INVENTION

The invention relates to a method of applying a two-component composition and in particular a two-component pavement marking composition as well as an apparatus suitable for mixing, dispensing and spraying small volumes of a two-component composition.

### BACKGROUND OF THE INVENTION

The use of pavement markings to guide and direct motorists traveling along a roadway is well known. During the daytime the markings are visible under ambient light to effectively signal and guide a motorist. At night, many pavement markings such as lane lines on roadways exhibit retroreflective properties. Upon illumination by a motorist's vehicle headlights the light from the headlight hits the pavement marking and is reflected so that much of the incident beam is directed back towards its source.

The most common retroreflective pavement markings are made by dropping transparent glass or ceramic optical elements onto a freshly painted line such that the optical elements become partially embedded therein. The transparent optical elements each act as a spherical lens and thus, the incident light passes through the optical elements to the base paint striking pigment particles therein. The pigment particles scatter the light redirecting a portion of the light back into the optical element such that a portion is then redirected back towards the light source.

The time between application of a pavement marking and the time at which the marking composition will no longer transfer to vehicle tires is defined as the “track-free” time. Shorter track-free times increase marking efficiency by reducing or eliminating the need for traffic disruption through such measures as closing lanes or placing traffic control devices to protect such markings. More recently, various end users are requiring track-free times of less than two minutes. In order to meet this requirement, it is preferred to employ a two-component composition that will react rapidly once the components are mixed together. A preferred example of such is described in U.S. Pat. No. 6,166,106.

Examples of commercially available pavement marking application equipment is found in various catalogs such as from MB Companies, New Holstein, Wis.; Linear Dynamics, Montgomery, Pa.; AST Corporation, Minneapolis, Minn. and Graco Company, Minneapolis, Minn. Such commercially available equipment for applying two-component pavement markings generally consists of storage receptacles for each component that are connected via hoses to reciprocating pumps to volumetrically meter the components. The metered components are then fed by means of hoses to an in-line blending means, such as a static mixing tube, or impingement type. This equipment also typically includes a spray applicator. In addition to this equipment being relatively expensive and rather complex to operate, such equipment generally requires at least 5 gallons of material to effectively operate. A portion of the composition is wasted upon transferring the composition from its original container to the storage receptacle. Additional waste is created from flushing the lines (i.e. hoses) prior to use.

Accordingly, industry would find advantage in a relatively inexpensive apparatus and methods of application that can be used for smaller jobs such as small municipalities as well as contractors and government agencies desiring to make quick and/or smaller scale applications or repairs.

### SUMMARY OF THE INVENTION

In one aspect the present invention relates to a method of applying a two-component pavement marking composition. The method comprises providing a two-component composition, advancing the composition into a mixing device forming a mixture; and dispensing the mixture with an applicator onto pavement. The first part is provided in a first chamber and the second part is provided in a second chamber. The total volume of the first and second chambers preferably ranges from about 0.1 liters to about 10 liters. In another embodiment, the total volume of the first and second chambers ranges from about 0.1 liters to about 20 liters and the composition is provided in an apparatus that is substantially free of hoses that continuously meter the composition.

In another aspect, the present invention relates to an apparatus comprising a means for accepting a two-component composition; a means for advancing the first part and second part into a static mixing device forming a mixture; and a means for spraying the mixture. In one embodiment, the two-component composition is provided in a removable cartridge. In another embodiment, the two-component composition is provided in a first chamber and a second chamber wherein the total volume of the first and second chambers ranges from about 0.1 liters to about 10 liters. In a third embodiment, the total volume of the first and second chambers ranges from about 0.1 liters to about 20 liters and the apparatus is substantially free of hoses that continuously meter the composition.

In another aspect, the invention relates to a method of applying a two-component composition comprising providing a two-component composition in a pair of chambers wherein the total volume of the chambers ranges from about 0.1 liters to about 10 liters; advancing the first part and second part into a static mixing device forming a mixture; and dispensing the mixture with a spray applicator. In another embodiment, the total volume of the chambers ranges from about 0.1 to about 20 liters and the composition is provided in an apparatus that is substantially free of hoses that continuously meter the composition.

The various embodiments of the method and apparatus of the invention preferably employ a pair of chambers wherein the total volume of the chambers is less than about 5 liters. The first chamber and second chamber are preferably provided in the form of a removable cartridge that preferably comprises a rigid material such as molded plastic or lined cardboard. The removable cartridge is preferably disposable. Alternatively, the first chamber and second chamber are provided by a rigid housing that may be removable or fixed to the apparatus. Removable collapsible tubes may be provided within the first and second chambers or each component may be poured into the appropriate chamber. Further, such embodiments preferably entail providing the composition in a hand-held gun-type applicator that may optionally comprise a harness or be further attached to a cart having wheels.

The various embodiments of the method and apparatus of the invention preferably employ a static mixing element as the mixing device. The static mixer preferably comprises a rigid plastic material and is disposable. The applicator is preferably a spray head that dispenses the mixture as a mist. Alternatively, the applicator may provide a substantially continuous line having a width of at least about 5 cm such as can be applied with a ribbon extrusion head. The line preferably has a film thickness of at least about 0.25 mm when dispensed at a distance of less than about 15 cm.

A preferred method of applying the two-component pavement marking composition comprises:

a) providing a two-component composition in a cartridge wherein the first part is provided in a first chamber of the cartridge, the second part is provided in a second chamber of the cartridge and the total volume of the cartridge ranges from about 0.1 liters to about 5 liters;

b) mixing the first part and second part by means of advancing the first part and second part through a disposable static mixing tube; and

c) dispensing the mixture onto pavement with a spray applicator.

In the various embodied methods of pavement marking, the methods optionally comprise embedding a plurality of optical elements in the mixture after dispensing the mixture on the pavement, thus preparing a retroreflective marking.

### BRIEF DESCRIPTION OF THE DRAWINGS

FIG. 1 illustrates a plan view of an apparatus embodied by the present invention.

FIG. 2 illustrates a perspective view of a disposable plastic two-component cartridge, a static mixing tube, a shroud, and a spray head that are assembled prior to use.

FIG. 3 illustrates a plan view and a cross sectional view of the chambers of an apparatus embodied by the present invention after insertion of a static mixing element and a two-component composition.

### DETAILED DESCRIPTION OF THE PREFERRED EMBODIMENT

The method of the invention generally relates to mixing and dispensing a multi-component composition and in particular a multi-component pavement marking composition. Since the majority of multi-component compositions are two-component compositions, the terminology “two-component” will be used hereinafter and refers to a composition having at least two components that are initially provided as unmixed separate portions until use. The two-component composition for use in the apparatus or method of the invention is typically reactive. However, provided that the composition is provided in at least two separate portions that are subsequently combined in the apparatus, the composition may also be non-reactive. For example, an uncolored pavement marking composition could be provided in the first chamber and a colorant composition provided in the second chamber.

Suitable reactive two-component compositions for use in the invention generally include epoxies, polyurethanes, alkyds, acrylics, polyesters, phenolics and the like. Various epoxies, polyurethane, polyureas, and polyesters are generally described is U.S. Pat. Nos. 3,254,563; 3,418,896 and 3,272,827; incorporated herein by reference. A preferred two-component composition has an amine component including one or more aspartic ester amines and optionally one or more amine-functional co-reactants and an isocyanate component including one or more polyisocyanates, as described in U.S. Pat. No. 6,166,106, incorporated herein by reference. Such reactive two-component pavement marking compositions typically further comprise fillers, extenders, pigments and combinations thereof. These compositions share the common feature that both parts are liquids at ambient temperature prior to reacting. After the components are mixed, applied and cured the mixture becomes substantially solid.

The viscosity of the liquid components is typically less than about 10,000 cps, as measured according to ASTM D 2196-99 at a temperature ranging from about 0° C. to about 40° C. The viscosity is generally at least a few hundred centipoises and preferably ranges from about 1000 cps to about 2000 cps. In order to obtain good mixing, particularly with a static mixing device, the viscosity of the first component is preferably similar to the viscosity of the second component. For the majority of compositions wherein, the difference in viscosity is less than about 5 to 1, a standard 6 mm mixing tube having 18 mixing elements (i.e. stages) provides adequate mixing. For differences in viscosity of greater than 5 to 1 a static mixing tube having greater than 18 elements may be employed.

The method comprises providing a two-component composition; advancing both components into a mixing device forming a mixture; and dispensing the mixture with an applicator onto pavement. In providing the composition, each part is provided in a separate chamber. Thus, for a two-part composition the first part is provided in a first chamber and the second part is provided in a second chamber. Accordingly, prior to advancing each part into the mixing device, each component of the composition is provided as a separate portion. As used herein, “chamber” refers to an enclosed space or compartment. Accordingly, each chamber comprises a discrete volume of each component rather than the components being continuously metered from a receptacle.

The total volume of the chambers generally may range from about 0.1 liters to less than 20 liters and preferably less than about 15 liters. The total volume is preferably at least about 200 ml and more preferably at least about 400 ml since it typically requires at least about 200 ml to make a highly visible marking having a surface area of about 4 ft² (929 cm²) at a film thickness of about 0.5 mm. The total volume is preferably sufficiently small such that the apparatus for applying the composition can be easily hand-held and operated. Thus the total volume is preferably less than about 10 liters and more preferably about 5 liters or less. The volume of each separate chamber varies depending on the ratio at which the components are intended to be combined. For example, for a two-component composition in which the parts are to be mixed at a 1:1 ratio, the volume of each chamber is typically approximately the same. In the case of a composition in which the parts are to be mixed at a ratio of 1:2, one of the chambers is typically approximately twice the volume relative to the other chamber.

In the method of the invention the first and second chambers are preferably provided in the form of a removable cartridge. The cartridge may be refillable, yet is typically disposable. In one embodiment, the cartridge is comprised of a rigid material. As used herein, “rigid” refers to the ability of the cartridge to maintain its shape after being filled with a liquid two-component composition at ambient temperature. Such rigid cartridges can be molded from various thermoplastic materials such as polyethylene. Additionally rigid disposable cartridges can be formed from cardboard, and the like, having a lining that prevents leakage and premature curing, as are known in the art. Alternatively, a removable or permanently attached rigid housing can be provided that is capable of receiving the two-component composition. Particularly for instances wherein the same composition is being repeatedly used, each liquid component can be poured into the appropriate chamber. Preferably, however, each component is contained within a collapsible material such as a tube comprising a thermoplastic film, a metal foil, or multi-layer construction of various barrier layers to prevent leakage and premature curing.

Although any suitable means for advancing the first part and second part from the chamber into the mixing device could be employed, the components are typically advanced by means of a pneumatic dispenser positioned at one end of the cartridge or housing. The cartridge or housing is equipped with a pair of pistons corresponding in size and shape to the interior dimensions of each chamber. The pistons are forced into the chambers by means of the pneumatic dispenser that in turn forces the contents of the chambers through an outlet at the opposing end of the cartridge or housing and subsequently through the mixing device. If a ribbon extrusion head is employed as the applicator, the pneumatic dispenser also typically advances the mixture through the applicator onto the pavement. In such embodiment, the method employs a single means for mixing and dispensing the two-component composition. In the case of various spray head applicators, however, a separate means, such as a second air supply, typically contributes to the dispensing of the mixture. Typically the pneumatic dispenser applies force to the pistons of both chambers such that the components are displaced from the chambers at the appropriate mix ratio, the mix ratio being controlled by the cross-sectional area of the piston. Alternatively, however, the dispenser could be equipped with separate plungers such that each plunger could displace the volume of the chamber at a different rate to achieve the desired mix ratio.

In the method of applying the two-component pavement marking composition of the present invention, the mixing device, the means for dispensing the mixture, as well as the applicator itself are without limit provided that a sufficiently visible marking is obtained. Various tests that are employed to evaluate the sufficiency of a pavement marking are described in ASTM D 2205-85 “Standard Guide for Selection of Tests for Traffic Paints”. Although other mixing devices can suitably be employed in the method of pavement marking of the invention, a static mixer, and in particular a disposable static mixing tube is preferred for obtaining a homogeneous mixture of small volumes of materials. Disposable static mixing tubes generally comprise a rigid plastic material and are commercially available from the distributor BondPro, Hudson, Wis. under the trade designation “MixPac”.

The type of applicator is generally chosen depending on the intended marking type. Typically, the marking is made with a stencil such as in the case of a handicap marking, arrows, legends, school crossings and the like. For such markings the applicator is generally a spray head such as an atomization spray head, nebulizer spray head or other applicator head, such as commercially available from AST Corporation, Minneapolis, Minn. under the trade designation “Spray sleeve assembly part, part number 55832-01”, that can provide a mist of the pavement marking composition mixture. It is surmised that a shaping spray head wherein the output is shaped like a fan is preferred for obtaining a pavement marking of uniform thickness. For non-stenciled markings, however, such as lane lines, other applicators, such as a ribbon extrusion head (i.e ribbon spreader tips) are also suitable provided the applicator is capable of providing a substantially continuous line having a width of at least about 5 cm. Preferably such applicators provide a film thickness of at least about 0.010″ (0.25 mm) at a distance of less than about 6 inches (15.2 cm), such that a highly visible marking is obtained with a single pass. Suitable ribbon spreader tips are commercially available from ConProTech Inc., Salem, N.H. under the trade designations “BSD 10-40” and “BSD 10-25”

For many pavement markings, such as lane lines, that require night visibility in addition to daytime visibility, the method preferably comprises applying a plurality of optical elements on the viewing surface of the pavement marking composition mixture after application yet prior to curing. In order to obtain an optimum balance of bonding between the optical elements in combination with optimum retroreflectivity, preferably at least about 50% of the total number of optical elements are embedded to a depth of about 40% to about 60%.

A wide variety of optical elements may be employed in the method of the invention. The optical elements may be in the form of any shape such as granules, flakes (e.g. aluminum flakes) and fibers. Typically, the optical elements have a refractive index of about 1.5 to about 2.6. Spheroidal transparent elements, also described as “beads”, “glass beads” and “glass-ceramic beads” are typically preferred. Alternatively, however, reflective elements comprising a core and a plurality of optical elements partially embedded in the core such as described in U.S. Pat. Nos. 5,774,265 and 3,274,888 may also be employed.

Typically, for optimal dry retroreflectivity, the optical elements have a refractive index ranging from about 1.5 to about 2.0 and preferably ranging from about 1.5 to about 1.9. For optimal wet retroreflectivity, the optical elements have a refractive index ranging from about 1.7 to about 2.65, preferably ranging from about 1.9 to 2.65, and more preferably ranging from about 2.1 to about 2.65.

The pavement marking may comprise optical elements having the same, or approximately the same refractive index. Alternatively, the reflective element may comprise optical elements having two or more refractive indices. When a blend of optical elements having different refractive indices is used, the ratio of the higher refractive index optical elements to the lower refractive index optical elements is preferably about 1.05 to about 1.4, and more preferably from about 1.08 to about 1.3.

The optical elements can be colored to retroreflect a variety of colors. Further, the optical elements can be color matched to the marking paints in which they are embedded. Techniques to prepare colored ceramic optical elements that can be used herein are described in U.S. Pat. No. 4,564,556. Colorants such as ferric nitrate (for red or orange) may be added in the amount of about 1 to about 5 weight percent of the total metal oxide present. Color may also be imparted by the interaction of two colorless compounds under certain processing conditions (e.g., TiO₂ and ZrO₂ may interact to produce a yellow color).

Pavement markings often further comprise skid-resistant particles to reduce slipping by pedestrians, bicycles, and motor vehicles. The skid-resistant particles can be, for example, ceramics such as quartz, aluminum oxide, silicon carbide or other abrasive media.

Prior to use, the apparatus of the invention generally comprises a means for receiving a two-component composition, a means for advancing the composition through a passage into a static mixing device, and a means for spraying the mixture. The two-component composition is preferably provided in a disposable cartridge. Alternatively, the apparatus may comprise a housing having at least two chambers. The chambers may be filled for example by pouring each liquid component into the appropriate chamber or more preferably by placing a collapsible tube into each chamber, each tube comprising a different portion of the two-component composition. Unlike an apparatus in which each component is continuously fed by means of a hose, the volume of each chamber is fixed and relatively small as previously described. Further, the apparatus is substantially free of hoses, eliminating waste of material and time as a result of flushing such hoses prior to use.

Due to the relatively small discrete volumes, the apparatus of the invention can conveniently be hand-held and hand operated. The hand-held apparatus may further comprise a harness, particularly in the case of an apparatus designed to accommodate higher volumes of material (e.g. greater than 5 liters). Alternatively, the apparatus may be mounted onto a cart having wheels. This is also advantageous for handling higher volumes of materials as well as for pavement markings that are made without a stencil, such as lane line markings.

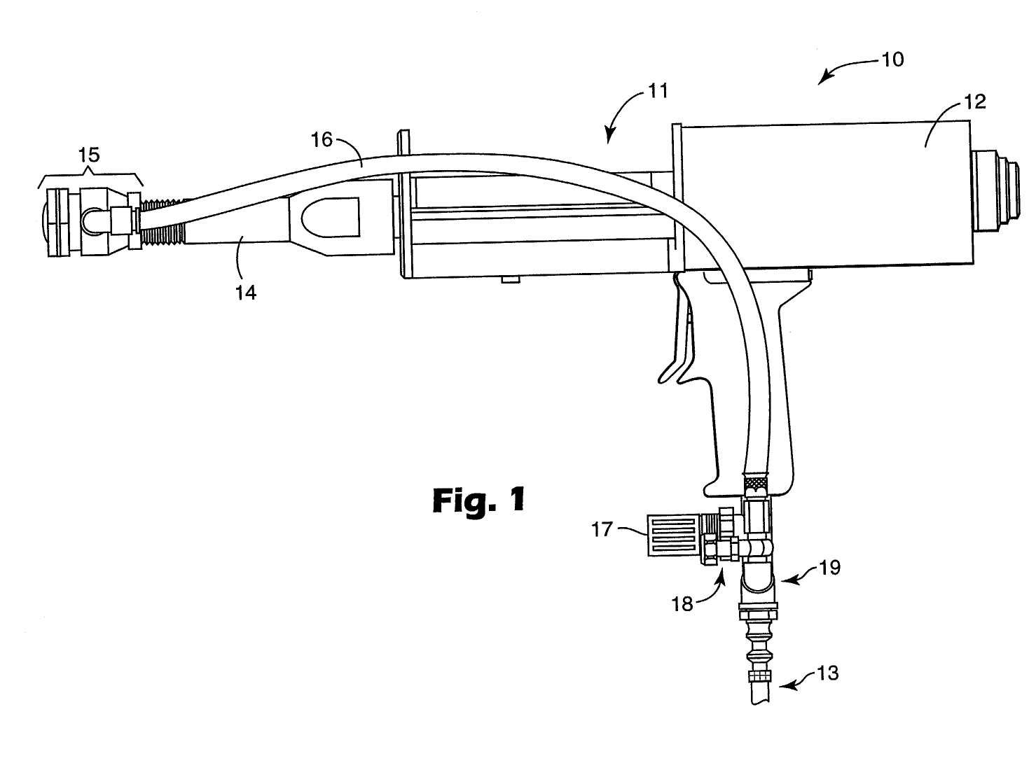

In a preferred embodiment, depicted in FIG. 1, the apparatus 10, prior to use, comprises a pneumatic dispenser 12, a cavity 11 capable of receiving a dual-chamber cartridge, a shroud 14 extending from the cavity that houses a mixing device, and a spray applicator 15. An air supply line 13 having a regulator 17 extends through the interior of the handle of the gun (not shown) to the pneumatic dispenser 12 in order to provide a “power supply” for the pneumatic dispenser. The pneumatic dispenser 12 provides a means of advancing the contents of the chambers through the shroud 14 that houses the mixing device and through the spray applicator 15 for spraying the mixture onto the intended surface (e.g. pavement). In the case of the majority of spray applicators that also necessitate an air supply 16, a single air supply hose can be equipped with T-fitting 19 on the air supply line and a second airflow regulator 18 such that the same air supply can be used to advance the contents of the chambers as well as spray the mixture.

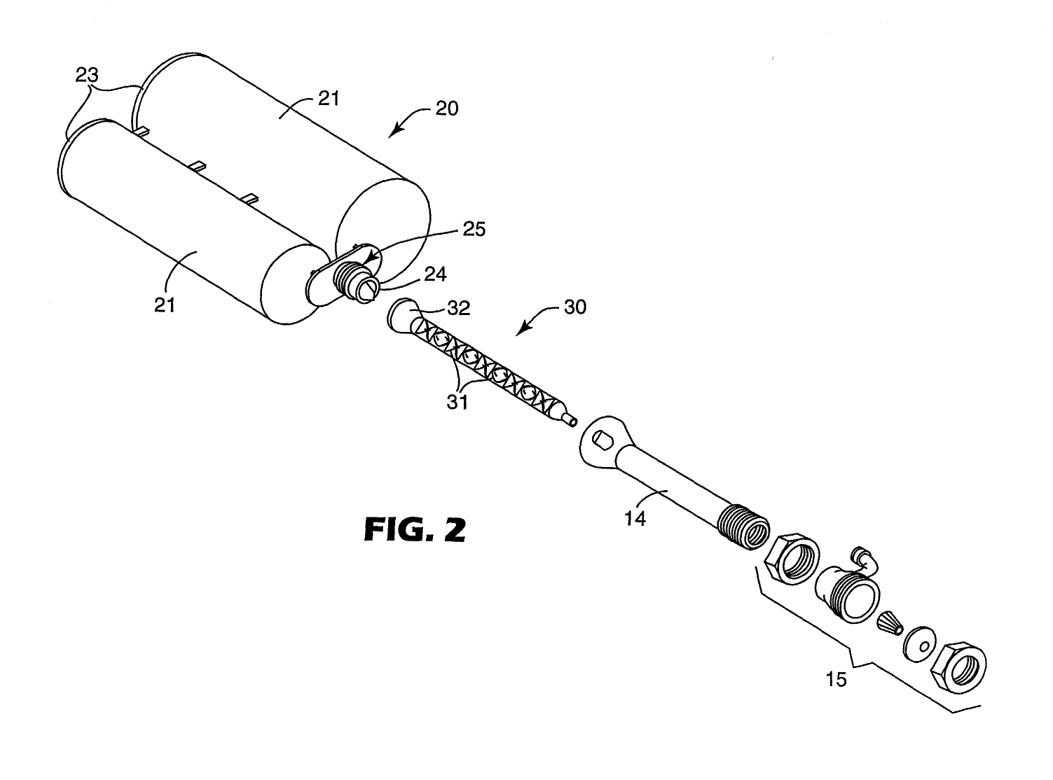

Prior to use the shroud 14 and spray head 15 are removed from the apparatus of FIG. 1 and assembled with a cartridge 20 and static mixing tube 30 as depicted in FIG. 2. A preferred cartridge 20 for use in the apparatus of FIG. 1 has two parallel cylindrical shaped internal chambers 21, each of which is filled with a separate part of a two-component material, e.g., polymerizable resin. The exterior of the chambers of the cartridge are typically, but not necessarily connected, yet the internal chambers are separated. The cartridge comprises a pair of pistons 23 at one end and a pair of outlet passages at the opposing end that merge at a common outlet passage 24. The common outlet passage is equipped with a means for attachment to either the static mix tube and/or to the shroud. The common outlet passage is preferably a threaded cylindrical barrel 25 having a separation in the interior of the barrel that prevents mixing of the components prior to the point at which the components entering the mixing device. The disposable static mixing tube 30, comprises a plurality of counter-rotated auger-like mixing blades 31 attached to a common shaft within a cylindrical hollow housing 32. The static mixing tube housing 32 is secured to the threaded barrel 25 with a retaining nut or other suitable attachment means in order to fix the mixing tube to the cylindrical barrel of the cartridge. Preferably, the shroud 14 is also attached to the threaded barrel and thus aids in retaining the static mixing tube on the cartridge.

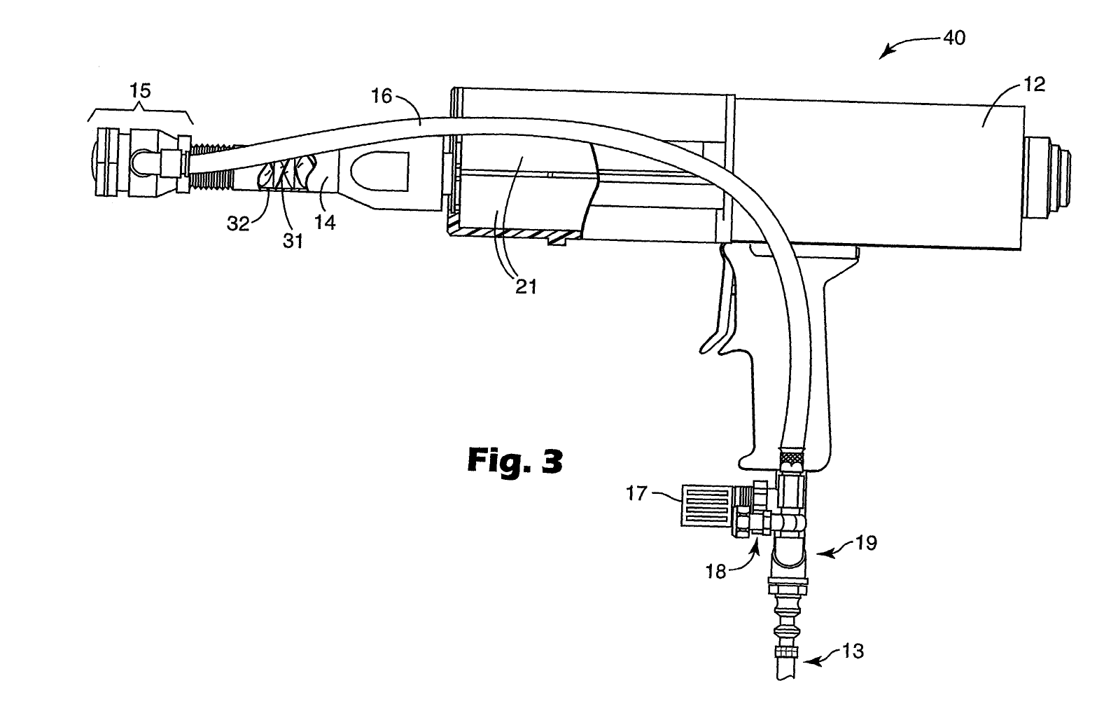

The assembly of the cartridge 20 fixed to the static mixing tube 30, shroud, and spray head 15 is then placed into the apparatus of FIG. 1 followed by attaching air supply 16 to spray head 15, as depicted by 40 of FIG. 3. During use, the pistons 23 are forced into the chambers by the pneumatic dispenser, and the contents of the chambers is forced through the common outlet passage 24 into the static mixing tube. The static mixing elements and also the spray applicator (e.g. atomizer, nebulizer) intimately mix the previously separate portions of the two-component composition forming a substantially homogeneous mixture. The mixture typically rapidly cures (e.g. crosslinks) following expulsion from the spray applicator 15.

Alternatively, a non-disposable static mixing element could be used in place of a disposable mixing tube. In such embodiment, the shroud alone may be attached to the common outlet passage with a static mixing element 31 (in the absence of a housing) maintained in place during use by a suitable constriction in the inside diameter of the shroud. In another embodiment the chambers may be fixed to the gun adjacent the pneumatic dispenser. In such embodiment, the gun would typically be equipped with a releasable hinge near the handle such that the fixed dual-chamber portion can be tilted downward with respect to the handle exposing the pistons of the chambers. The pistons can then be removed in order to refill the respective chambers.

Objects and advantages of the invention are further illustrated by the following examples, but the particular materials and amounts thereof recited in the examples, as well as other conditions and details, should not be construed to unduly limit the invention

Assembly of the Apparatus

An apparatus, illustrative of the apparatus of FIG. 3 was assembled as follows:

A hand-held cartridge dispensing system having a cavity and a pneumatic dispenser was obtained from Bondpro Corporation, Hudson, Wis. under the trade designation “Type DP 400-85-01” Bondpro Corporation is a distributor of “Mixpac Systems” from ConProTec. Inc. The pneumatic dispenser was modified by the addition of a T-fitting on the compressed air supply line prior to the regulator. A second regulator was added with a line for attachment to the spray head, allowing independent control of airflow to the spray head.

A static mixing tube commercially available from Bondpro Corporation under the trade designation “Statomix MC 06-18” was attached to the threaded barrel end of a 400 ml dual cartridge. The cartridge together with the piston assembly, plugs, and retaining nut was also obtained from Bondpro Corporation, under the trade designation “Mixpac MP 400-02-14”. The retaining nut and cartridge plug was removed and then the opposing end of the static mix tube was inserted in a shroud that was preassembled to a spray head, commercially available from AST Corporation, Minneapolis, Minn. under the trade designation “Promarker II part #55832-01”.

The assembly of the cartridge, static mixing tube housed within the shroud, and spray head was inserted into the pneumatic dispenser. The air supply line connected to the T-fitting was attached to the spray head at the opposing end.

Application of a Two-Component Pavement Marking Composition

The air supply line was disconnected from the spray head and the assembly of the cartridge, static mixing tube housed within the shroud, and the spray head was removed from the pneumatic dispenser, and disassembled. The larger of the two chambers of the dual cartridge was filled with the first part of a two-component pavement marking composition, commercially available from Minnesota, Mining and Manufacturing (“3M”), St. Paul, Minn. under the trade designation “Stamark brand LPM 1500 part A”. The appropriate piston assembly was inserted into the chamber. The smaller of the two chambers was then filled with the second part of a two-component pavement marking composition, commercially available from 3M under the trade designation “Stamark brand LPM 1530 part B”, followed by the piston assembly. The piston of the cartridge has a cross-sectional area that displaces the materials at the desired ratio of two parts of part A to one part of part B. (The piston area of the chamber having part B is half that of the piston area of the chamber for part A.) The cartridge, static mixing tube, shroud and spray head were reassembled, as previously described and inserted into the pneumatic dispenser gun. The air supply line was reconnected to the spray head and an air supply line was connected to the gun near the bottom of the handle.

To form a pavement marking, a stencil with an opening of approximately 12″ (30 cm) by 72″ (183 cm) was placed on a paved asphalt surface. The pneumatic dispenser regulator was adjusted to approximately 80 psi to provide flow rate of about 400 ml/minute of the liquid through the static mix tube. The regulator for the atomizing air was set to approximately 40 psi to provide a mist for spray application. The dispenser assembly was inverted (spray tip pointed downward) over the stencil and the system actuated. The gun was moved at a rate of approximately 15 ft/min (4.6 m/min) with the tip held about 6 inches above the surface. In this fashion a 4″ (10 cm) wide line was formed having a thickness of about 0.020″ (0.51 mm). Three adjacent and slightly overlapping passes were required to completely cover the 12″ (31 cm) opening of the stencil. Immediately following the application of the liquid, glass beads, commercially available from Flex-O-Lite, Chesterfield, Mo. under the trade designation “AASHTO Type M247-81” were sprinkled on at a rate of approximately 0.1 lbs/ft². The stencil was removed and the coating having a plurality of embedded glass beads was allowed to cure for 10 minutes. At this point the marking would support the weight of an automobile without significant deformation or tracking.

A portable reflectometer, commercially available from Light and Optics, Denmark under the trade designation “Model LTL2000” was used to measure the retroreflectance of the marking in accordance with ASTM D4061. A value of 346 mcd/m²/lux was recorded. The marking was closely inspected and found to be uniformly cured and of good appearance. No difference could be observed between a marking produced using this method and that produced using the more complex device prepared in the same fashion with a commercially available pavement marking apparatus commercially available from AST under the trade designation “Promarker II”.

What is claimed is:

1. A method of applying a two-component pavement marking composition comprising:
providing a two-component composition wherein a first part is provided in a first chamber and a second part is provided in a second chamber and wherein the first and second chambers have a total volume ranging from about 0.1 liters to about 10 liters;
advancing the first part and second part into a mixing device forming a mixture; and
dispensing the mixture with an applicator onto pavement.

2. The method of claim 1 wherein the total volume of the first and second chambers is less than 5 liters.

3. The method of claim 1 wherein the composition is provided in a hand-held gun-type applicator.

4. The method of claim 1 wherein the first chamber and second chamber are provided in the form of a removable cartridge.

5. The method of claim 4 wherein the removable cartridge comprises a rigid material.

6. The method of claim 5 wherein the removable cartridge comprises molded plastic.

7. The method of claim 5 wherein the removable cartridge comprises lined cardboard.

8. The method of claim 4 wherein the removable cartridge is disposable.

9. The method of claim 1 wherein the first chamber and second chamber are provided by a rigid housing.

10. The method of claim 9 wherein removable collapsible tubes are provided within the first and second chambers.

11. The method of claim 9 wherein the two-component composition is poured into the first and second chambers.

12. The method of claim 1 wherein the mixing device is a static mixer.

13. The method of claim 12 wherein the static mixer comprises a rigid plastic material.

14. The method of claim 13 wherein the static mixer is disposable.

15. The method of claim 1 wherein the applicator is a spray head

16. The method of claim 15 wherein the spray head dispenses the mixture as a mist.

17. The method of claim 1 wherein the applicator provides a substantially continuous line having a width of at least about 5 cm.

18. The method of claim 17 wherein the line has a film thickness of at least about 0.25 mm when dispensed at a distance of less than about 15 cm.

19. The method of claim 1 wherein the applicator is a ribbon extrusion head.

20. The method of claim 1 further comprising embedding a plurality of optical elements in the mixture after dispensing the mixture on the pavement.

21. A method of applying a two-component pavement marking composition comprising:
providing a two-component composition wherein a first part is provided in a first chamber and a second part is provided in a second chamber and wherein the first and second chambers have a total volume ranging from about 0.1 liters to about 20 liters;
advancing the first part and second part into a mixing device forming a mixture; and
dispensing the mixture with an applicator onto pavement;
wherein the composition is provided in an apparatus that is substantially free of hoses that continuously meter the composition.

22. A method of applying a two-component pavement marking composition comprising:
providing a two-component composition in a cartridge wherein a first part is provided in a first chamber of the cartridge, a second part is provided in a second chamber of the cartridge and the cartridge has a total volume ranging from about 0.1 liters to about 5 liters;
mixing the first part and second part by means of advancing the first part and second part through a disposable static mixing tube;
dispensing the mixture onto pavement with a spray applicator.

23. An apparatus comprising:
a means for accepting a cartridge wherein the cartridge comprises at least two chambers wherein the first chamber comprises a first part of a two-part composition and the second chamber comprises a second part of a two-part composition;
a means for advancing the first part and the second part from the cartridge into a static mixing device forming a mixture; and
a means for spraying the mixture.

24. The apparatus of claim 23 wherein the first and second chambers have a total volume of less than 5 liters.

25. The apparatus of claim 23 wherein the apparatus is substantially free of hoses that continuously feed meter the composition.

26. The apparatus of claim 23 wherein the cartridge is comprised of a rigid plastic material.

27. The apparatus of claim 23 wherein the static mixing device is a disposable static mixing tube.

28. The apparatus of claim 23 wherein the means for spraying provides the mixture as a mist.

29. The apparatus of claim 23 wherein the apparatus is a hand-held gun-type applicator.

30. The apparatus of claim 23 further comprising a harness.

31. The apparatus of claim 23 wherein the apparatus is further attached to a cart having wheels.

32. An apparatus comprising:
a first chamber and a second chamber wherein the first and second chambers have a total volume ranging from about 0.1 liters to about 10 liters;
a means for advancing the composition provided in the chambers into a static mixing device forming a mixture; and
a means for spraying the mixture.

33. An apparatus comprising:
a first chamber and a second chamber wherein the first and second chambers have a total volume ranging from about 0.1 liters to about 20 liters;
a means for advancing a composition provided in the chambers into a static mixing device forming a mixture; and
a means for spraying the mixture;
wherein the apparatus is substantially free of hoses that continuously meter the composition.

34. A method of applying a two-component composition comprising:
providing a two-component composition wherein the first part is in a first chamber and the second part is in a second chamber and wherein the first and second chambers have a total volume ranging from about 0.1 liters to about 10 liters;
advancing the first part and the second part into a static mixing device forming a mixture; and
dispensing the mixture with a spray applicator.

35. A method of applying a two-component composition comprising:
providing a two-component composition wherein the first part is in a first chamber and the second part is in a second chamber and wherein the first and second chambers have a total volume ranging from about 0.1 liters to about 20 liters;
advancing the first part and the second part into a static mixing device forming a mixture; and
dispensing the mixture with a spray applicator;
wherein the composition is provided in an apparatus that is substantially free of hoses that continuously meter the composition.

36. A pavement surface having a marking prepared according to the method of claim 1.

37. A pavement surface having a marking prepared according to the method of claim 21.

38. A pavement surface having a marking prepared according to the method of claim 22.
